(19) United States
(12) Patent Application Publication
(10) Pub. No.: US 2009/0142943 A1
(43) Pub. Date: Jun. 4, 2009

(54) CONNECTOR AND ELECTRONIC DEVICE HAVING THE SAME

(75) Inventors: Mu-Tsai Chang, Taipei (TW); Chao-Feng Kang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/258,458

(22) Filed: Oct. 27, 2008

(30) Foreign Application Priority Data
Nov. 29, 2007 (TW) 96145419

(51) Int. Cl. H01R 12/00

(52) U.S. Cl. 439/78

(57) ABSTRACT

An electronic device including a circuit board and a connector disposed on the circuit board is provided. The connector includes a connecting body having a first surface and a second surface, a plurality of first leads, and a plurality of second leads. The first leads and the second leads are inter-arranged in the connecting body. A slot is disposed on the first surface. Each of the first leads has a first connecting portion and a second connecting portion. Each of the second leads has a third connecting portion and a fourth connecting portion. The first connecting portions and the third connecting portions are located in the slot. The second connecting portions and the fourth connecting portions are protruded from the second surface and extended toward different directions. The circuit board includes pads connected to the second connecting portions and conductive holes for the fourth connecting portions to insert therein.

### CROSS-REFERENCE TO RELATED APPLICATION

This application claims the priority benefit of Taiwan application serial no. 96145419, filed on Nov. 29, 2007. The entirety of the above-mentioned patent application is hereby incorporated by reference herein and made a part of this specification.

### BACKGROUND OF THE INVENTION

1. Field of the Invention

The present invention generally relates to a connector, in particular, to a connector capable of being disposed on a circuit board more stably and an electronic device having the same.

2. Description of Related Art

Generally speaking, an electronic device is usually disposed therein with a connector and is electrically connected to an expansion device by the connector, so as to expand the use performance of the electronic device. With the progress of technology, the electronic device develops towards the trend of lightness and thinness. Correspondingly, the connector disposed in the electronic device should also be miniaturized to accord with the trend of lightness and thinness of the electronic device. The connector conforms to the standard of micro-space after being miniaturized.

It should be noted that, a space between leads of the connector is small after the connector is miniaturized. Thus, when the connector is arranged on a circuit board by a surface mount technology (SMT), it is not easy for the SMT process to control an electrical connection relationship between each of the leads and the circuit board, which results in an empty solder between a part of the leads and the circuit board. Furthermore, two adjacent leads are easy to contact each other improperly due to the overly small space, which easily causes a short circuit in the connector.

On the other hand, a contact area between the leads of the connector and pads of the circuit board is reduced greatly after the connector is miniaturized. Thus, the leads of the connector are quite not easy to be fixed on the pads. In this way, the connector is hard to be disposed on the circuit board stably and is easy to fall off the circuit board due to the influence of an improper external force, thus resulting in a poor structural reliability of the electronic device.

### SUMMARY OF THE INVENTION

Accordingly, the present invention is directed to a connector suited to be arranged on a circuit board stably.

The present invention is directed to an electronic device having a good structural reliability.

The present invention provides a connector, which includes a connecting body and a plurality of first leads and second leads arranged in the connecting body. The connecting body has a first surface and a second surface parallel to the first surface, and a slot is disposed on the first surface. Each of the first leads has a first connecting portion and a second connecting portion. The first connecting portions are located in the slot, and the second connecting portions are extended along a first direction and protruded from the second surface. Furthermore, each of the second leads has a third connecting portion and a fourth connecting portion. The third connecting portions are located in the slot, and the fourth connecting portions are extended along a second direction and protruded from the second surface. The first direction is perpendicular to the second direction, and the fourth connecting portions and the second connecting portions are inter-arranged.

In an embodiment of the present invention, the first connecting portions and the third connecting portions are arranged in the slot in equal intervals along a third arrangement line.

In an embodiment of the present invention, a space between the two adjacent second connecting portions or a space between the two adjacent fourth connecting portions is twice that between the adjacent first connecting portion and third connecting portion.

In an embodiment of the present invention, the second direction is perpendicular to the second surface.

The present invention provides an electronic device, which includes a circuit board and a connector described above. The circuit board includes a plurality of pads corresponding to the first leads and a plurality of conductive holes corresponding to the second leads. The second connecting portion of each of the first leads is electrically connected to each of the pads, and the fourth connecting portion of each of the second leads is inserted in and electrically connected to each of the conductive holes.

In an embodiment of the present invention, the electronic device further includes a plurality of solders, each disposed between each of the fourth connecting portions and each of the conductive holes.

In the present invention, a part of the leads of the connector are suited to be arranged on the pads of the circuit board horizontally by a surface mount technology (SMT), and a proper space exists between the two adjacent second connecting portions. Therefore, the electrical connection relationship between each of the second connecting portions and the pad can be effectively controlled by the SMT, and the problem of empty solder is not easy to occur.

In addition, a part of the leads may be vertically inserted in and electrically connected to the conductive holes of the circuit board. The present invention reduces the improper contact between the leads of the miniaturized connector and the problem of empty solder between the leads and the circuit board by use of the different extension directions of the leads. Furthermore, since this part of the leads are directly inserted in the circuit board, the connector can be disposed on the circuit board stably in combination with the use of the solders, and can hardly fall off the circuit board due to the influence of an improper external force. That is to say, the electronic device in the present invention has a good structural reliability.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional view of an electronic device according to an embodiment of the present invention.

FIG. 1B is an exploded view of the electronic device in FIG. 1A.

FIG. 2 is a three-dimensional bottom view of a connector in FIG. 1B.

FIG. 3 is a three-dimensional bottom view of the electronic device in FIG. 1A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

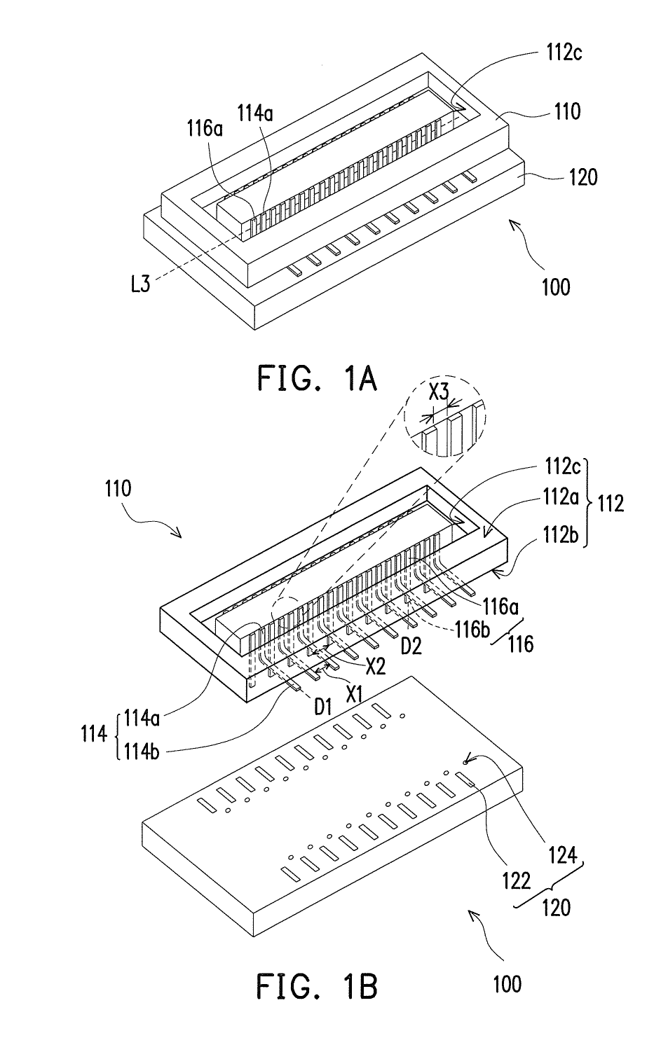

FIG. 1A is a three-dimensional view of an electronic device according to an embodiment of the present invention, and FIG. 1B is an exploded view of the electronic device in FIG. 1A. Referring to FIGS. 1A and 1B, the electronic device 100 includes a connector 110 and a circuit board 120. The connector 110 mainly includes a connecting body 112 and a plurality of first leads 114 and second leads 116 arranged in the connecting body 112. In this embodiment, a material of the connecting body 112 is an insulating material or other proper material. The connecting body 112 has a first surface 112a and a second surface 112b parallel to the first surface 112a, and a slot 112c is disposed on the first surface 112a. The connector 110 is electrically connected to the circuit board 120, and an inserter, (such as a connecting joint of an expansion device, not shown) may be inserted in the slot 112c, so as to be electrically connected to the circuit board 120 by the connector 110, thereby enabling the electronic device 100 to have good use performance. The constitutional members of the connector 110, a structure of the circuit board 120, and the connection relationship between the connector 110 and the circuit board 120 will be illustrated below in this embodiment.

In this embodiment, the first leads 114 and the second leads 116 are inter-arranged in the connecting body 112. Each of the first leads 114 has a first connecting portion 114a and a second connecting portion 114b, and each of the second leads 116 has a third connecting portion 116a and a fourth connecting portion 116b. The first connecting portions 114a and the third connecting portions 116a are located in the slot 112c, so as to be electrically connected to an inserter. The second connecting portions 114b and the fourth connecting portions 116b are protruded from the second surface 112b and extended toward different directions respectively.

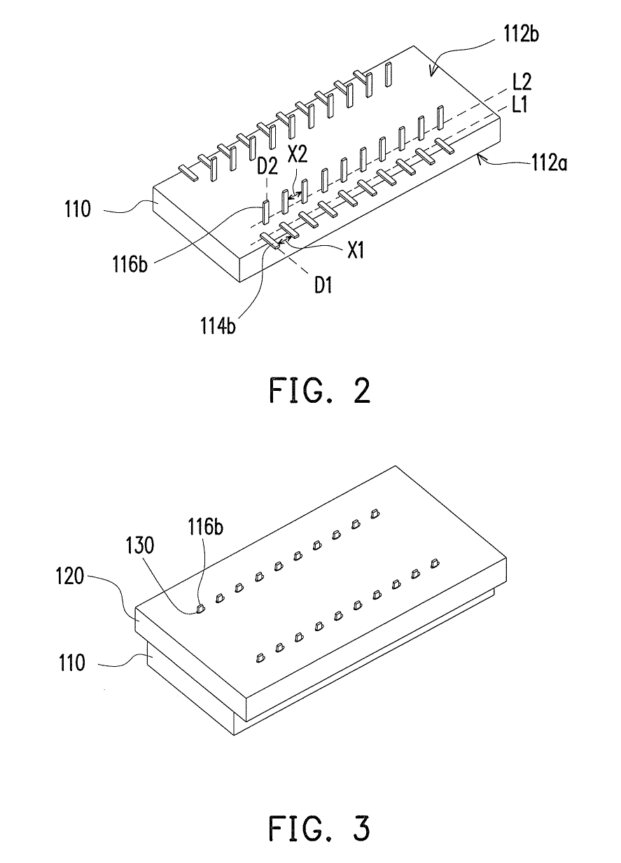

In order to clarify the extension directions of the second connecting portions 114b and the fourth connecting portions 116b after protruding from the second surface 112b, please refer to FIG. 2, and FIG. 2 is a three-dimensional bottom view of a connector in FIG. 1B. In this embodiment, the second connecting portions 114b are extended along a first direction D1 of the second surface 112b away from the connecting body 112, while the fourth connecting portions 116b are extended along a second direction D2 away from the connecting body 112. The first direction D1 is parallel to the second surface 112b, and the second direction D2 is perpendicular to the second surface 112b, that is, the first direction D1 and the second direction D2 are perpendicular to each other.

Furthermore, the second connecting portions 114b are disposed at positions close to at least one side edge of the second surface 112b (the second connecting portions 114b shown in FIG. 2 are disposed at positions close to two side edges of the second surface 112b) and arranged along a first arrangement line L1. The fourth connecting portions 116b are disposed along a second arrangement line L2 and inter-arranged with the second connecting portions 114b. In this embodiment, the second arrangement line L2 is parallel to the first arrangement line L1. The above second arrangement line L2 is located at an inner side of the first arrangement line L1, and the first arrangement line L1 and the second arrangement line L2 are preferably spaced by a proper distance.

Referring to FIGS. 1A and 1B again, the first connecting portions 114a and the third connecting portions 116a disposed in the slot 112c are inter-arranged in the slot 112c along a third arrangement line L3. The first connecting portions 114a and the third connecting portions 116a are arranged in the slot 112c in equal intervals. A space X1 between the two adjacent second connecting portions 114b or a space X2 between the two adjacent fourth connecting portions 116b at the bottom of the connector 110 is preferably twice a space X3 between the adjacent first connecting portion 114a and third connecting portion 116a.

It should be noted that, although the first leads 114 and the second leads 116 are inter-arranged in the connecting body 112, a proper space exists between the two adjacent second connecting portions 114b or the two adjacent fourth connecting portions 116b because the first leads 114 and the second leads 116 of the connector 110 are extended toward different directions after protruding from the connecting body 112. That is, the second connecting portions 114b of the first leads 114 are not coplanar with the fourth connecting portions 116b of the second leads 116, such that the two adjacent leads are not easy to contact each other improperly to cause a short circuit. Even after the connector 110 is miniaturized, a proper space remains between the two adjacent second connecting portions 114b or the two adjacent fourth connecting portions 116b, thus effectively reducing the occurrence of the above short circuit.

Then, the structure of the circuit board 120 and the connection relationship between the connector 110 and the circuit board 120 will be illustrated in this embodiment. Referring to FIG. 1B, the circuit board 120 in this embodiment mainly includes a plurality of pads 122 and a plurality of conductive holes 124. The pads 122 correspond to the above first leads 114 and are arranged on one surface of the circuit board 120, and the second connecting portions 114b of the first leads 114 are suited to be electrically connected to the pads 122 by a surface mount technology (SMT). Furthermore, the conductive holes 124 correspond to the above second leads 116 and penetrate the body of the circuit board 120. When performing the above SMT process, the fourth connecting portions 116b of the second leads 114 are suited to be inserted in and electrically connected to the conductive holes 124.

In addition, FIG. 3 is a three-dimensional bottom view of the electronic device in FIG. 1A. Referring to FIG. 3, a section of the fourth connecting portion 116b is protruded from a bottom surface of the circuit board 120 after the fourth connecting portion 116b is inserted in the conductive hole 124. At this time, the fourth connecting portion 116b may be electrically connected to the conductive hole 124 through a solder 130, and the connection relationship between the connector 110 and the circuit board 120 may be enhanced. It is understood that, each of the second connecting portions 114b may also be electrically connected to each of the pads 122 through the solder.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connector comprising:
a connecting body, having a first surface and a second surface parallel to the first surface, wherein a slot is disposed on the first surface;
a plurality of first leads, arranged in the connecting body, wherein each of the first leads has a first connecting portion and a second connecting portion, the first connecting portions are located in the slot, and the second connecting portions are extended along a first direction and protruded from the second surface; and
a plurality of second leads, arranged in the connecting body, wherein each of the second leads has a third connecting portion and a fourth connecting portion, the third connecting portions are located in the slot, and the fourth connecting portions are extended along a second direction and protruded from the second surface;
wherein the first direction is perpendicular to the second direction, and the fourth connecting portions and the second connecting portions are inter-arranged.

2. The connector according to claim 1, wherein the first connecting portions and the third connecting portions are arranged in the slot in equal intervals.

3. The connector according to claim 1, wherein a space between the two adjacent second connecting portions or a space between the two adjacent fourth connecting portions is twice that between the adjacent first connecting portion and third connecting portion.

4. The connector according to claim 1, wherein the second direction is perpendicular to the second surface.

5. An electronic device comprising:
a connector, comprising:
a connecting body, having a first surface and a second surface parallel to the first surface, wherein a slot is disposed on the first surface;
a plurality of first leads, arranged in the connecting body, wherein each of the first leads has a first connecting portion and a second connecting portion, the first connecting portions are located in the slot, and the second connecting portions are extended along a first direction and protruded from the second surface;
a plurality of second leads, arranged in the connecting body, wherein each of the second leads has a third connecting portion and a fourth connecting portion, the third connecting portions are located in the slot, and the fourth connecting portions are extended along a second direction and protruded from the second surface; and
a circuit board, comprising a plurality of pads corresponding to the first leads and a plurality of conductive holes corresponding to the second leads, wherein the second connecting portion of each of the first leads is electrically connected to each of the pads, and the fourth connecting portion of each of the second leads is inserted in and electrically connected to each of the conductive holes;
wherein the first direction is perpendicular to the second direction, and the fourth connecting portions and the second connecting portions are inter-arranged.

6. The electronic device according to claim 5, wherein the first connecting portions and the third connecting portions are arranged in the slot in equal intervals.

7. The electronic device according to claim 5, wherein a space between the two adjacent second connecting portions or a space between the two adjacent fourth connecting portions is twice that between the adjacent first connecting portion and third connecting portion.

8. The electronic device according to claim 5, further comprising a plurality of solders on the circuit board, each of the solders connecting each of the fourth connecting portions and each of the conductive holes.

9. The electronic device according to claim 5, wherein the second direction is perpendicular to the second surface.
